(19) United States
(12) Patent Application Publication
(10) Pub. No.: US 2006/0104220 A1
(43) Pub. Date: May 18, 2006

(54) Method and apparatus for managing configuration information, and configuration information managing system using the apparatus

(76) Inventors: Naoko Yamazaki, Koganei (JP); Keisuke Kagamimori, Yokohama (JP); Arata Izumoto, Yokohama (JP); Takao Baba, Sodegaura (JP); Eiji Ohira, Hamura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/226,332

(22) Filed: Sep. 15, 2005

(30) Foreign Application Priority Data
Nov. 11, 2004 (JP) 2004-327937

(51) Int. Cl. H04L 12/28; G06F 15/177; G06F 15/173

(52) U.S. Cl. 370/254; 709/220; 709/223

(57) ABSTRACT

A configuration information management server apparatus is provided with a unit collecting configuration information from the device connected to a network, a unit storing the configuration information collected from the device connected to the network, and a unit comparing already stored information with the collected information and reporting in case there is an abnormality. Moreover, the configuration information management server apparatus is provided with a storage unit for configuration information for validation use for temporarily storing configuration information for validation use for the purpose of configuring the network device, a configuration information comparator unit comparing the collected configuration information with the configuration information for validation use, and a configuration information storage unit storing, in case the configuration information collected in the configuration information comparator unit and the configuration information for validation use match, the collected data in a configuration information historical database.

### INCORPORATION BY REFERENCE

The present application claims priority from Japanese application JP 2004-327937 filed on Nov. 11, 2004, the content of which is hereby incorporated by reference into this application.

### BACKGROUND OF THE INVENTION

The present invention is related to a configuration information management method for network devices, a management apparatus, and a management system, and pertains in particular to a configuration information management method for network devices, a management apparatus, and a management system that enable a reduction in processing man-hours for updates of configuration information.

When maintenance staff maintain a network, it is common to carry this out by managing the configuration information (setting information) of network devices connected to the network. Then, the management of the network device configuration information is carried out by directly connecting a console device with the network devices, by means of a cable or the like, and by letting the maintenance staff manipulate the console apparatus in real time to acquire the configuration information.

As prior art pertaining to the management of configuration information of network devices as aforementioned, the art described in JP-A-2002-190809 and so forth is known. This prior art is one wherein a network device management apparatus called a manager is installed on the network maintenance operator site, a network device maintenance apparatus called an agent is installed on the customer site, and network device configuration information is managed hierarchically.

Specifically, the agent is connected to the several network devices to be managed and holds the setting information of the network devices under its command. When processing is performed of the settings for initial and additional installations, connection changes, swaps, and so forth, of the network devices, the agent registers the setting information in the generation management file within the manager together with saving the setting information internally, after completing the processing. Moreover, the agent, following the instructions of the manager, reads the setting information of the network devices periodically and compares the read setting information with the most recently set setting information held by the agent, and as a result of that, in case there is a disparity in the contents, transmits the new setting information to the manager together with saving the read setting information as the new setting information. The manager, having received the new setting information, registers the concerned generation management file and notifies the customer that the setting information has been changed.

Also, as other prior art, e.g. the art described in “Tripwire for Network Devices”, “Tripwire Products” published on the Internet (search on Jun. 10, 2004) by Tripwire, Inc., under the URL <http://www.tripwire.com/products/network_devices/index .cfm> or the like is known. This prior art is one that pertains to a system and a method which remotely collect the setting information of network devices and, by performing a single management of this change history, are set up to implement an improved efficiency of the crisis management of network devices and safe network operation.

### SUMMARY OF THE INVENTION

The prior art described in the aforementioned JP-A-2002-190809 adopts a method wherein the contents of the configuration information of the network devices are stored inside the system. When a change in the configuration information is detected, there arises a need to determine whether that change is an expected regular change, an unauthorized alteration (a fraudulent change) such as an unauthorized alteration of a routing (e.g., fraudulent change of an IP address), or an incorrect change due an entry mistake. Also, in the contents of the configuration information left in the state as acquired, there may be changed portions which may be disregarded. Consequently, it becomes necessary to compare the acquired configuration information with the original, correct configuration information (the correctly changed configuration information), and to remove manually that part of the acquired configuration information which may be disregarded, so an amount of human treatment processes ends up increasing. Specifically, this prior art has the problem that, in case the configuration information of the network devices is changed, an amount of human treatment processes for judging whether the change contents are appropriate ends up increasing.

It is an object of the present invention to solve the problems of the aforementioned prior art by offering a configuration information management method for network devices, a management apparatus, and a management system enabling a reduction in the number of processing man-hours for updating and managing configuration information.

According to one aspect of the invention, the configuration information management method for network devices, in a configuration information management apparatus communicatively connected to at least one network device and collecting and managing the configuration information from the network devices, includes the steps of:
in advance temporarily storing and saving configuration information for validation use for configuring the network device, in the configuration information management apparatus;
comparing the configuration information collected from the network devices with the saved configuration information for validation use; and
in case, as a result of the comparison, the information of that portion of the collected configuration information which should be compared matches the configuration information for validation use, storing the collected configuration information in a configuration information historical database.

According to another aspect of the present invention, in the configuration information management apparatus, communicatively connected to at least one network device and collecting and managing the configuration information from the network devices, the configuration information management apparatus includes:
a storage unit for configuration information for validation use, for temporarily storing configuration information for validation use for configuring the network device;
a comparator unit for configuration information, comparing the configuration information collected from the network devices with the configuration information for validation use; and
a historical database for configuration information, storing the collected configuration information, in case the information of that portion of the collected configuration information which should be compared matches the configuration information for validation use.

According to yet another aspect of the present invention, in a configuration information management system for network devices, the system being provided with a configuration information management apparatus communicatively connected to at least one network device and collecting and managing the configuration information from the network device
and at least one configuration information management client apparatus communicatively connected to the configuration information management device and wherein the configuration information management apparatus collects and manages the configuration information in accordance with the instructions from the configuration information management client apparatus,
the configuration information management apparatus is provided with:
a storage unit for configuration information for validation use, for temporarily storing configuration information for validation use, for configuring the network device;
a comparator unit for configuration information, comparing the configuration information collected from the network devices with the configuration information for validation use; and
a historical database for configuration information, storing the collected configuration information, in case the information of that portion of the collected configuration information which should be compared matches the configuration information for validation use.

According to the present invention, it is possible to reduce an amount of man-hours for the updating and management of the configuration information of network devices.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the composition of a configuration information management system for network devices according to an embodiment of the present invention.

FIG. 2 is a block diagram showing the hardware composition of a configuration information management server apparatus.

FIG. 3 is a sequence diagram explaining the functioning of processes whereby the configuration information management server apparatus manages the configuration information.

FIG. 4 is a flowchart explaining the collection and change detection of configuration information in the configuration information management server apparatus.

FIG. 5 is a diagram showing a window displayed in the client apparatus in the process of registering configuration information for validation use.

FIG. 6 is a diagram showing the window displayed in the client apparatus in the configuration information collection setting process and the change detection extension period setting process.

FIGS. 7A and 7B are sequence diagrams explaining the functioning of the processes whereby the configuration information management server apparatus manages the corrective pattern information.

FIGS. 8A, 8B, and 8C are diagrams showing windows displayed in the client apparatus in the configuration information corrective pattern management process.

FIG. 9 is a diagram showing the composition of the user information table stored in the user information database (DB).

FIG. 10 is a diagram showing the composition of the device type information table stored in the device type information database.

FIG. 11 is a diagram showing the composition of the node information table stored in the node information database.

FIG. 12 is a diagram showing the composition of the table of configuration information for validation use stored in the database for configuration information for validation use.

FIG. 13 is a diagram showing the composition of the collection management information table stored in the collection management information database.

FIG. 14 is a diagram showing the composition of the temporarily archived configuration information table stored in the database for temporary archiving of configuration information.

FIGS. 15A and 15B are diagrams showing respectively the compositions of the configuration information history table and the generation information table stored in the configuration information historical database.

FIG. 16 is a diagram showing the composition of the corrective pattern information table stored in the pattern file of the device type information database.

### DETAILED DESCRIPTION OF THE EMBODIMENTS

Below, an embodiment of the configuration information system for network devices according to the present invention will be described in detail with reference to the drawings.

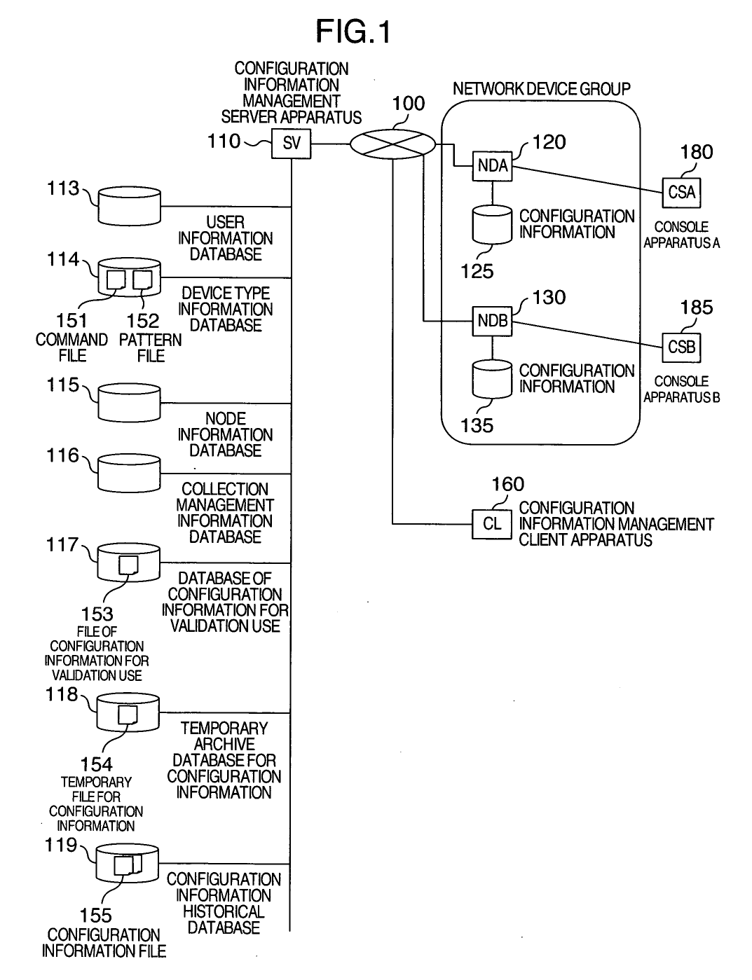

FIG. 1 is a block diagram showing the composition of the configuration information system for network devices according to an embodiment of the present invention. In FIG. 1, the reference 100 designates a network, 110 a configuration information management server apparatus (SV), 113 a user information database (DB), 114 a device type information database, 115 a node information database, 116 a collection management information database, 117 a database for configuration information for validation use, 118 a configuration information temporary archive database, 119 a configuration information historical database, 120 a network device A (node NDA), 130 a network device B (node NDB), 125 and 135 configuration information, 151 a command file, 152 a pattern file, 153 a file of configuration information for validation use, 154 a temporary file for configuration information, 155 a configuration information file, 160 a configuration information management client apparatus (CL), 180 a console apparatus (CSA), and 185 designates a console apparatus (CSB).

The configuration information management system for network devices according to an embodiment of the present invention is, as shown in FIG. 1, constituted so as to enable configuration information management server apparatus 110 and several network devices A 120, B 130 (in the explanation below also sometimes called nodes) to be connected through network 100 and communicate mutually.

In the description above, configuration information management server apparatus 110 is a computer managing the configuration information of the network device group based on network devices A 120, B 130. Network 100 may e.g. be the Internet, leased lines, a VPN (Virtual Private Network), or the like. Network device A 120 is able to communicate with several other network devices and stores its own configuration information 125. Configuration information 125 is the host name and port information etc. and network device setting information. Below, starting from the network devices directly or indirectly connected to network 100, a plurality of network devices communicatively connected through the network, directly or indirectly, will be called a network device group. Network device A 120 can be connected to console apparatus 180 via a cable, and it is possible to change the configuration information of network device A 120 from console apparatus 180. Regarding network device B 130 as well, it stores, in the same way as network device A 120, its own configuration information 135, can be connected to console apparatus 185 via a cable, and the configuration information of network device B 130 can be modified from console apparatus 185.

Moreover, configuration information management server apparatus 110 is communicatively connected with configuration information client apparatus 160 through network 100.

Further, the embodiment of the present invention shown in FIG. 1 describes the network communicatively connected to the network device group and the network communicatively connected with configuration information management client apparatus 160 as being one and the same network, but it is acceptable, in the present invention, for the network device group and configuration information management client apparatus 160 to be connected to different networks.

Configuration information management client apparatus 160 is a computer (below simply called a client apparatus) whereby the user utilizes configuration information management server apparatus 110. Client apparatus 160, by being connected to configuration information management server apparatus 110 through network 100, is capable of utilizing configuration information management server apparatus 110.

Further, configuration information management server apparatus 110 may be composed of a plurality of computers.

Configuration information management server apparatus 110 is provided with user information database 113 storing information for authenticating the user, device type information database 114 storing information dependent on the device types of the network devices (below called nodes), node information database 115 storing information for identifying the nodes, collection management information database 116 storing information for receiving the configuration information of the nodes, database 117 for configuration information for validation use storing files with configuration information for validation use generated by the user, configuration information temporary archive database 118 storing temporary configuration information files received from the nodes, and configuration information historical database 119 storing configuration information files and generation information received from the nodes.

Device type information database 114 stores command file 151 and pattern file 152. Command file 151 has on record command examples for configuration information acquisition for collection of configuration information by configuration information management server apparatus 110 and corresponds to the device type of the network device. Pattern file 152 has on record corrective patterns for correcting the configuration information received from the network devices.

Collection management information database 116 stores data for making configuration information management server apparatus 110 receive the configuration information of the network devices.

Database 117 for configuration information for validation use stores file 153 of configuration information for validation use. File 153 of configuration information for validation use is a file with the original correct configuration information (the correctly changed configuration information) and is a file with the original correct configuration information, made up of the minimum necessary information preferably.

Temporary archive database 118 for configuration information stores temporary configuration information file 154 storing the configuration information received by configuration information management server apparatus 110 from the network devices.

Configuration information historical database 119 stores configuration information file 155 storing the configuration information received by configuration information management server apparatus 110 from the network devices.

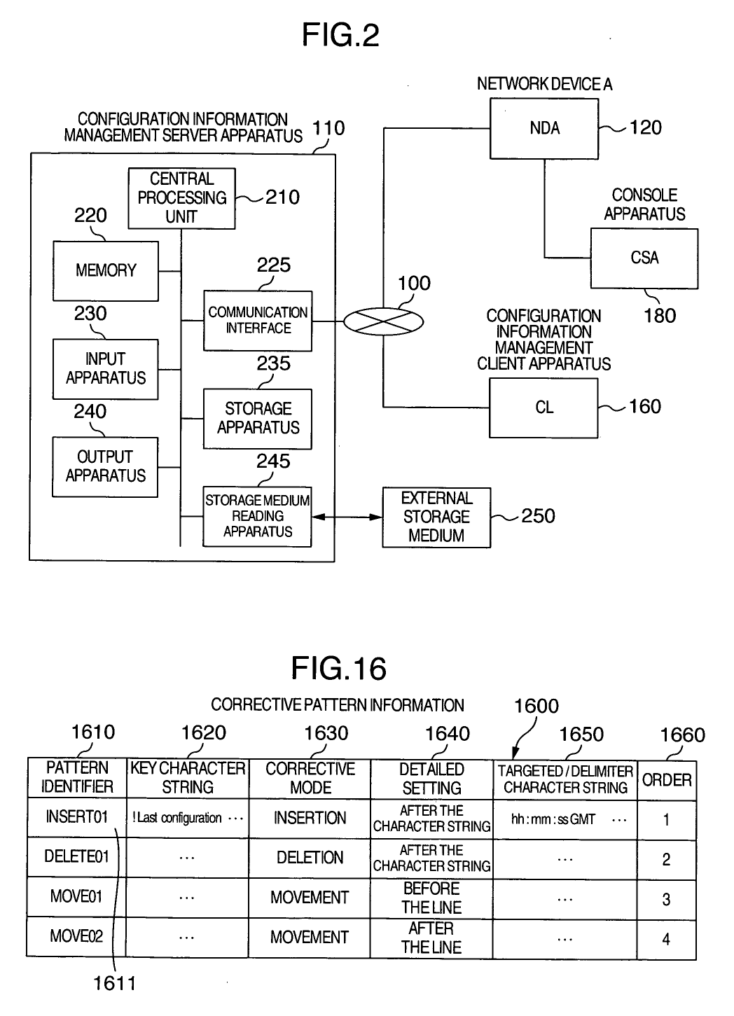

FIG. 2 is a block diagram showing the hardware composition of configuration information management server apparatus 110, and in FIG. 2, 210 designates a CPU (Central Processing Unit), 220 a memory, 230 an input apparatus, 240 an output apparatus, 225 a communication interface, 235 a storage apparatus, 245 a storage medium reading apparatus, and 250 designates an external storage medium.

Configuration information management server apparatus 110 is provided with and composed of CPU 210, memory 220, input apparatus 230, output apparatus 240, communication interface 225, storage apparatus 235 as well as storage medium reading apparatus 245.

Storage apparatus 235 is a storage means comprising e.g. magnetic disks such as hard disk drives. Moreover, the programs and so forth stored in storage apparatus 235 are sequentially stored in memory 220 by control of CPU 210. The programs stored in memory 220 are executed by CPU 210 and, as a result of this, the various processes subsequently described are implemented.

Storage medium reading apparatus 245 is e.g. a CD-ROM drive or the like which reads programs stored in an external storage medium 250 such as a CD-ROM and can store these in storage apparatus 235.

Input apparatus 230 is e.g. a keyboard, a mouse, or the like. Output apparatus 240 is e.g. a display, a printer, or the like. Communication interface 225 is an interface for communicating with configuration information management client apparatus 160 or network devices A 120, B 130, etc.

The hardware composition of client apparatus 160 for configuration information management may be a hardware composition similar to that of the configuration information management server apparatus 110 explained above, and is specifically provided with and composed of a CPU, a memory, an input apparatus, an output apparatus, a communication interface and a storage apparatus, etc.

The various databases 113 to 119 comprised in configuration information management server apparatus 110 in the configuration information management system for network devices based on the embodiment of the present invention explained above may be provided inside storage apparatus 235 composed of a hard disk drive (HDD) or the like, as shown and explained in FIG. 2, or inside an external storage medium 250 utilizing a rewritable storage medium. Also, the system may be provided with an independent storage apparatus provided with all the aforementioned databases 113 to 119 which is connected to configuration information management server apparatus 110. The contents of these databases 113 to 119 are utilized after being loaded into memory 220.

Also, client apparatus 160 for configuration information management may be provided in the vicinity of the network device group, or it may be provided in the vicinity of configuration information management server 110, or again, a plurality of configuration information management client apparatuses 160 may be provided in the vicinity of the network device group or configuration information management server 110, or, again, in an arbitrary location.

The embodiment of the present invention assumes that data are stored in user information database 113, device type information database 114, and node information database 115; in the following, the composition of these databases, as well as various databases provided in the embodiment of the present invention, will be explained.

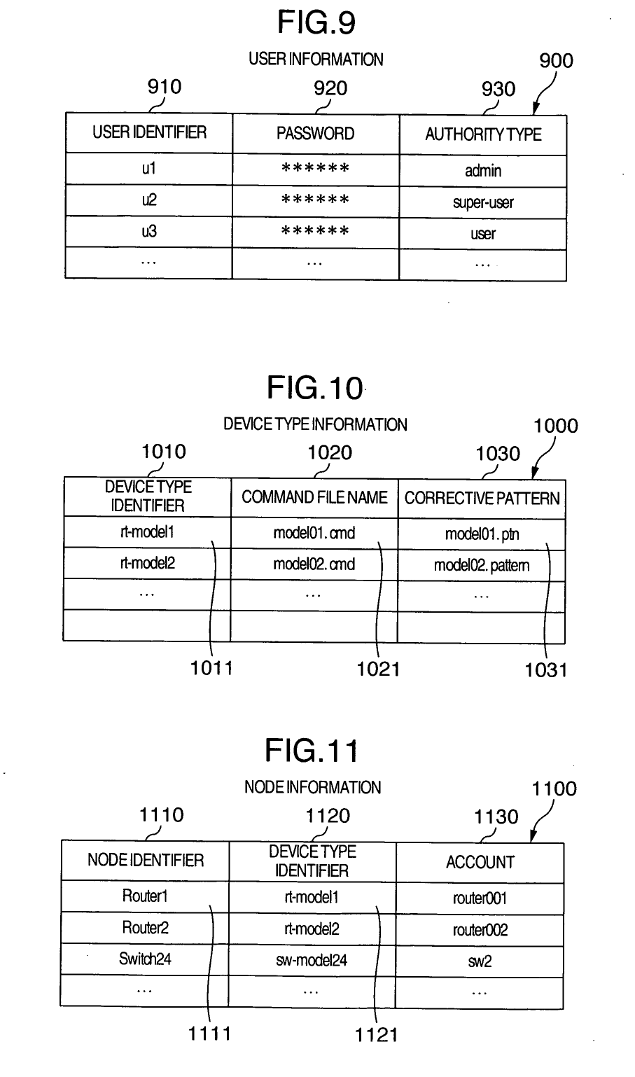

FIG. 9 is a diagram showing the composition of a user information table stored in user information database 113. User information table 900 associates user identifiers 910, passwords 920, and authority types 930, and is stored in user information database 113. User identifier 910 is a label identifying the user. Authority type 930 is a label showing the scope of the execution authority granted to the user, there being the “admin” label for which complete execution rights are granted, the “user” label for which partial execution rights are granted, the “super-user” label for which more execution rights are granted than to “user” users, and so forth. It is acceptable to impose restrictions on whether the user can execute or not the processes of the embodiment of the present invention by authority type 930.

FIG. 10 is a diagram showing the composition of a device type information table stored in device type information database 114. Device type information table 1000 associates device type identifiers 1010, command file names 1020 and corrective patterns 1030, and is stored in device type information database 114. Device type identifier 1010 is a label for identifying the device type of the network device. Command file name 1020 is a label of the name of a file in which is recorded the configuration information acquisition command string corresponding to the device type of the network device. Corrective pattern 1030 is a label of the name of a pattern file for correcting the configuration information received from the network device.

FIG. 11 is a diagram showing the composition of a node information table stored in node information database 115. Node information table 1100 associates node identifiers 1110, device type identifiers 1120, and accounts 1130, and is stored in node information database 115. Node identifier 1110 is a label for identifying the network device. Device type identifier 1120 is assumed to be an identifier selected from among device type identifier 1010 data stored in device type information table 1000 within device type information database 114 shown in FIG. 10.

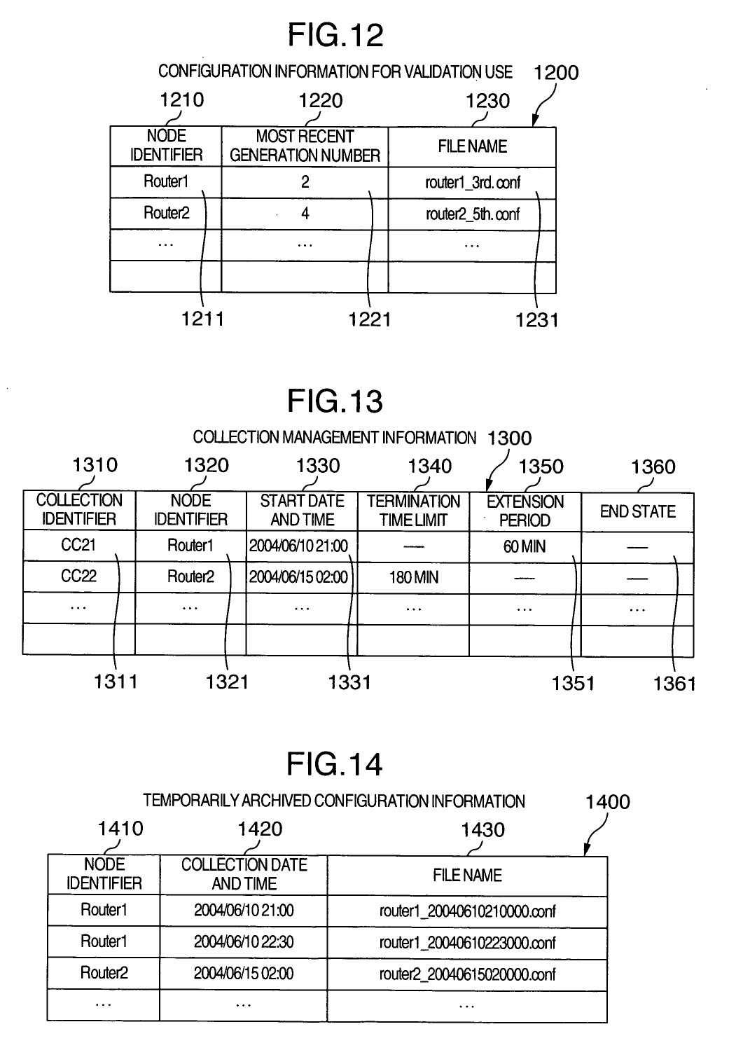

FIG. 12 is a diagram showing the composition of a table of configuration information for validation use, stored in database 117 for configuration information for validation use. Table 1200 of configuration information for validation use is a table of records associating node identifiers 1210, most recent generation numbers 1220, names of files 1230 for configuration information for validation use, and is stored in database 117 for configuration information for validation use.

FIG. 13 is a diagram showing the composition of a collection management information table stored in collection management information database 116. Collection management information table 1300 is a table of records associating collection identifiers 1310, node identifiers 1320, collection start dates and times 1330, collection termination time limits 1340 and change detection extension periods 1350, and is stored in collection management information database 116.

FIG. 14 is a diagram showing the composition of the table of temporarily archived configuration information stored in configuration information temporary archive database 118. Table 1400 of temporarily archived configuration information is a table associating node identifiers 1410, collection dates and times 1420, and temporary files 1430 for configuration information, related to configuration information collected from network devices, and is stored in configuration information temporary archive database 118.

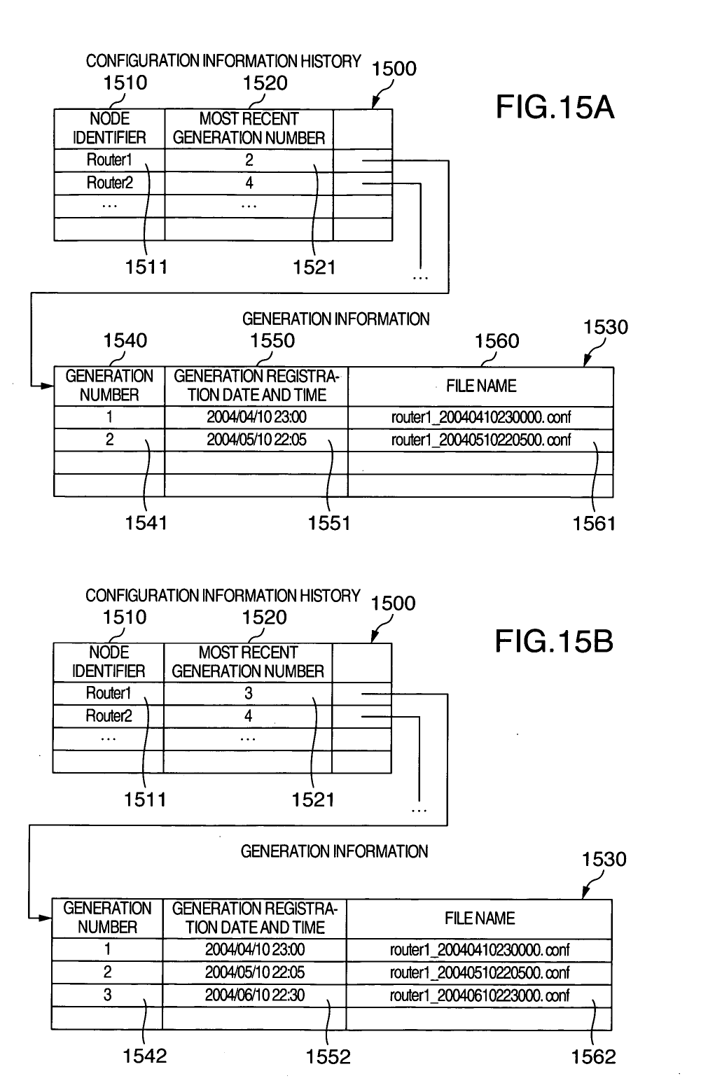

FIGS. 15A and 15B are diagrams showing the composition of a configuration information history table and a generation information table stored in configuration information historical database 119. Configuration information history table 1500 is a record associating and storing pointers to node identifiers 1510, most recent generation numbers 1520 and generation information tables 1530, and, additionally, generation information table 1530 is a record associating and storing generation numbers 1540, generation registration dates and times 1550, and file names 1560. These tables are stored in configuration information historical database 119.

FIG. 16 is a diagram showing the composition of the corrective pattern information table stored in pattern files 152 of device type information database 114. Corrective pattern information table 1600 is a record associating and storing pattern identifiers 1610, key character strings 1620, corrective modes 1630, detailed settings 1640, and targeted/delimiter character strings 1650, and is stored in pattern file 152 of device type information database 114.

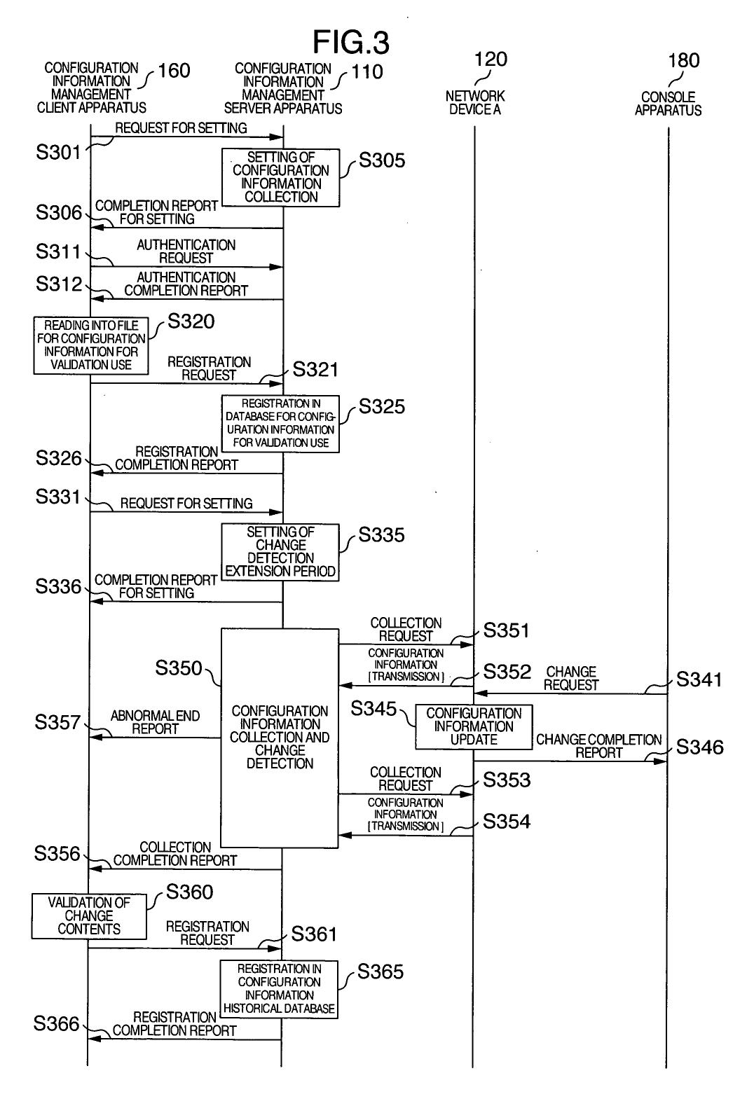

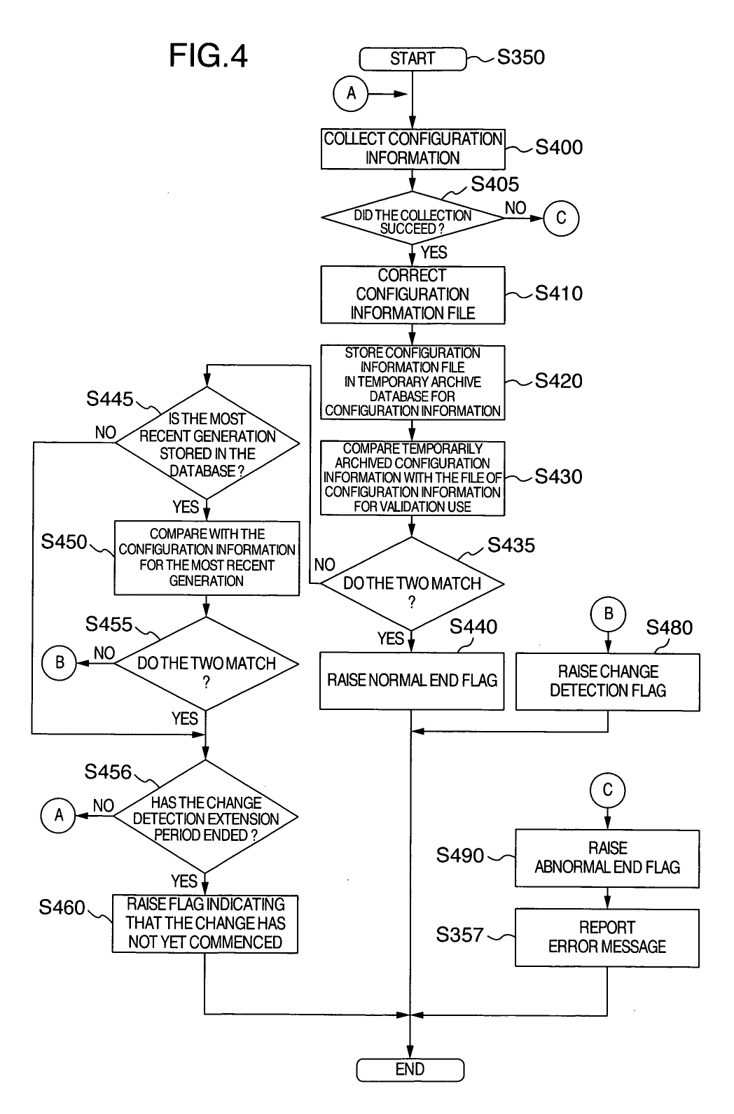

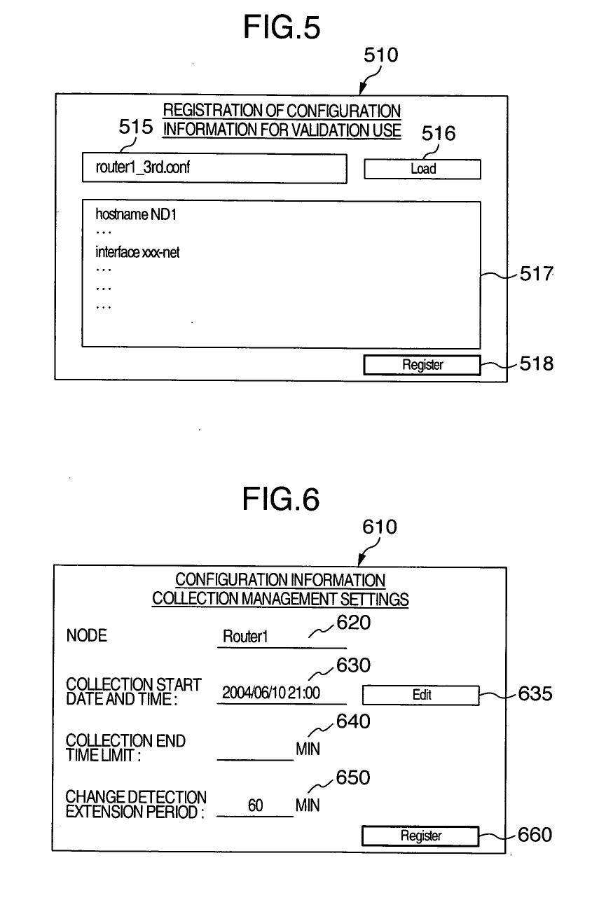

FIG. 3 is a sequence diagram explaining the functioning of processes whereby configuration information management server apparatus 110 manages configuration information, FIG. 4 is a flowchart explaining the functioning of processes for configuration information collection and change detection in configuration information management server apparatus 110, FIG. 5 is a diagram showing the window displayed in client apparatus 160 in the registration process of configuration information for validation use, and FIG. 6 is a diagram showing a window displayed in client apparatus 160 in the configuration information collection setting process as well as the change extension period setting process; in the following, the functioning of the processes whereby configuration information management server apparatus 110 manages the configuration information will be explained with reference to these diagrams. Moreover, the processes herein are assumed to be performed with respect to network device A 120 by a user using configuration information management server apparatus 110 from client apparatus 160. Also, at any intermediate time of this process, it is assumed that there can be performed changes in the configuration information of network device A 120 from console apparatus 180. In that case, the user of client apparatus 160 and the user of console apparatus 180 may be one and the same system administrator etc, or they may be different operators. In case the user of client apparatus 160 and the user of console apparatus 180 are different, it is assumed that both operators stay in mutual contact regarding the contents, etc., of the operations.
1. When the user, by using client apparatus 160, accesses configuration information management server apparatus 110, a configuration information collection management settings window 610 shown in FIG. 6 is displayed in client apparatus 160. When the user selects an “Edit” button 635 from configuration information collection management settings window 610, displayed in client apparatus 160 and shown in FIG. 6, and sets the collection start date and time to the wanted date and time, a character string showing the date and time set by the user is displayed in a collection start date and time display field 630. When the user selects a “Register” button 660, client apparatus 160 transmits a request for configuration information collection settings (Sequence S301) to configuration information management server apparatus 110.
2. When configuration information management server apparatus 110 receives the request for configuration information collection settings from client apparatus 160 in process S301, a collection management information table 1300, such as shown in FIG. 13, associating collection identifiers 1310, node identifiers 1320, collection start dates and times 1330, collection termination time limits 1340 and change detection extension periods 1350, is generated and stored in collection management information database 116 (Sequence S305).
3. When the configuration information collection setting process comes to an end in Sequence S305, configuration information management server apparatus 110 transmits a completion report for the configuration information collection setting process to client apparatus 160 (Sequence S306).
4. After the user has received the completion report for the configuration information collection setting process at client apparatus 160, he enters authentication information including and composed of a user identifier and a password from client apparatus 160. Client apparatus 160 transmits the entered authentication information to configuration information management server apparatus 110 (Sequence S311).
5. Configuration information management server apparatus 110 performs authentication of the user, based on the received authentication information, and, after termination of the authentication process, transmits an authentication completion report to client apparatus 160. Through the aforementioned process, the login of the user is completed (Sequence S312).
6. Since, when the processes mentioned so far have been completed, a registration window 510 for configuration information for validation use shown in FIG. 5 is displayed in the client apparatus, the user selects a file name entry field 515 for configuration information for validation from registration window 510 for configuration information for validation use, displayed in client apparatus 160, to enter the character string of a file name for configuration information for validation use, e.g. “router1_{—}3rd.conf”. Subsequently, when the user selects a “Load” button 516 from registration window 510 for configuration information for validation use, a read request for a file of configuration information for validation use is issued to the file system provided in his own client apparatus 160 (Sequence S320).

In the foregoing, the file of configuration information for validation use, stored in the file system of client apparatus 160, is information corresponding to changes in the configuration information of network devices that should be performed from console apparatus 180, and is stored in advance by the system administrator or the like in the file system of client apparatus 160.
7. In case the file corresponding to the name of the file of configuration information for validation use is stored in the file system, there are displayed the contents of the file of configuration information for validation use in a display field 517, for configuration information for validation use, in registration window 510 for configuration information for validation use. When the user selects a “Register” button 518, client apparatus 160 transmits a request for registration of the file of configuration information for validation use, together with the information in the file of configuration information for validation use, to configuration information management server apparatus 110 (Sequence S321). Also, regarding the file of configuration information for validation use displayed in display field 517 for configuration information for validation use, it is acceptable for the order of the character strings of the file of configuration information for validation to be different so long as the contents of the file of configuration information for validation is the same as the contents of the file of configuration information for comparison, described later.
8. When configuration information management server apparatus 110 receives a registration request for the file of configuration information for validation use, in the process of Sequence S321, there is generated a record in table 1200 of configuration information for validation use, whereby node identifiers 1210, most recent generation numbers 1220, file names 1230 of configuration information for validation use are associated, as explained in FIG. 12. This record, wherein e.g. something like node identifier “Router1” 1211, most recent generation number “2” 1221, and file name “router1_{—}3rd.conf” 1231 are associated, is stored in database 117 for configuration information for validation use (Sequence S325).

Further, in the aforementioned sequence, it is assumed that the name of the file of configuration information for validation use is stored in database 117 for configuration information for validation use, but in place of the file name, the contents of the file of configuration information for validation use may be stored in database 117 for configuration information for validation use.
9. In the processes of the sequences mentioned so far, since the process of storing the file of configuration information for validation use comes to an end, configuration information management server apparatus 110 transmits a report of completion of the registration process for the configuration information for validation use, to client apparatus 160 (Sequence S326).
10. If necessary, the user selects entry field 650 for the change detection extension period from settings window 610 for configuration information collection management shown in FIG. 6 and displayed in client apparatus 160 to enter data for the change detection extension period. This change detection extension period set and entered by the user is the period of time estimated to be required until the termination of the operation of updating the configuration information of a network device from console apparatus 180, and in case the operation of updating the configuration information has already been ended, it is acceptable not to enter anything or to enter a “0”. The entered time period is displayed by a character string in entry field 650 for the change detection extension period, and when the user selects a “Register” button 660, client apparatus 160 transmits a request for setting the change detection extension period to configuration information management server apparatus 110. Further, at this stage, it is assumed that the collection termination time limit is set by entry from client apparatus 160 (Sequence S331).
11. Configuration information management server apparatus 110 takes receipt of change detection extension period 650 set in settings window 610 for configuration information collection management, and, in case an extension period is set, stores change detection extension period 1350, for example, “60 min.”, in the record generated as described above and shown in FIG. 13, and stores it in collection management information database 116 (Sequence S335).
12. When the process of setting the change detection extension period in the process of Sequence S335 comes to an end, configuration information management server apparatus 110 transmits a completion report for the process of setting the change detection extension period to the client apparatus (Sequence S336).

Further, after the process of Sequence S336, configuration information management server apparatus 110 starts the configuration information collection and change detection processes in the processes of Sequence S350, but at this stage, when configuration information collection and change detection processes are performed, the explanation will be continued assuming that the configuration information of network device A 120 is updated from console apparatus 180. Moreover, regarding the details of the configuration information collection and change detection processes in the processes of Sequence S350, they will be subsequently described based on the flow shown in FIG. 4.
13. Now, it is assumed that an operator of the network maintenance staff or the like communicatively connects network device A 120 and console apparatus 180 via a cable and performs the configuration information change operation for the connected network device A 120. The processes of this operation will be explained specifically as follows. I.e., when the operator transmits a change request from console apparatus 180 to network device A 120 (Sequence S341), network device A 120 executes the update process of its own configuration information (Sequence S345). When the update process of the network device's (A 120) own configuration information comes to an end, network device A 120 transmits a completion report for the configuration information change to console apparatus 180 (Sequence S346).
14. In the configuration information collection and change detection processes starting after the process of Sequence S336, it is assumed that configuration information management server apparatus 110, periodically searches the record that collection start date and time 1330 has passed, from the records stored in collection management information table 1300 stored in collection management information database 116 and shown in FIG. 13. For example, in case 9.00 PM on Jun. 10, 2004, has passed, configuration information management server apparatus 110 identifies a record including collection start date and time “2004/06/10 21:00” 1331, and executes the configuration information collection and change detection processes (Sequence S350).
15. Configuration information management server apparatus 110 refers to the data stored in the identified record and determines that node identifier “Router1” 1321 is the network device that is the object of the configuration information collection process. Next, configuration information management server apparatus 110 refers to node information table 1100 stored in node information database 115 and shown in FIG. 11, and acquires the node information associated with node identifier “Router1” 1111. Also, configuration information management server apparatus 110 searches the record associated with device type identifier “rt-model1” 1121 acquired from node information database 115, from the record stored in device type information table 1000 stored in device type information database 114 and shown in FIG. 10, and acquires the device type information associated with device type identifier “rt-model1” 1011. Next, configuration information management server apparatus 110 communicates with the network device being the object of the configuration information collection process to transmit the configuration information collection request, along with the node information and the device type information (Sequence S351).
16. After that, there is performed the process of acquiring the configuration information of the network device, following the order described in command file “model01.cmd” 1021 of the record stored in device type information table 1000 shown in FIG. 10. Network device A 120, having received the configuration information acquisition request from configuration information management server apparatus 110, transmits its configuration information in accordance with the contents of the request (Sequence S352).
17. In case collection termination time limit 1340 has been set with the request in Sequence S331 from client apparatus 160, configuration information management server apparatus 110 reiterates the same processes as those mentioned above, within the collection termination time limit (Sequences S353, S354).
18. When the configuration information collection and change detection processes in the aforementioned Sequence S350 come to an end, configuration information management server apparatus 110 transmits a completion report for the configuration information collection and change detection processes to client apparatus 160 (Sequence S356).
19. Moreover, in the configuration information collection and change detection processes in Sequence S350, configuration information management server apparatus 110 interrupts the processes in case an abnormality has occurred, and transmits an abnormal end report to the client apparatus (Sequence S357).
20. The collection management information gradually transmitted from configuration information management apparatus 110 in Sequences S356, S357 are displayed in client apparatus 160. A user utilizing client apparatus 160 checks the displayed change contents and, in response to the change contents, transmits a configuration information registration request from client apparatus 160 to configuration information management server apparatus 110 (Sequences S360, S361).
21. When the configuration information management server apparatus 110 receives a configuration information registration request in the process of Sequence S361, it executes a registration process to configuration information historical database 119, and, after termination of the registration process, transmits a completion report for the configuration information registration to client apparatus 160 (Sequences S365, S366).

At this stage, an explanation regarding the process of Sequence S365 will be given. Configuration information management server apparatus 110 stores temporary file 154 for configuration information, received from network device A 120 in the process of Sequence S350 (details of which will subsequently be described) and stored in configuration information temporary archive database 118, as the configuration information file for the most recent generation in configuration information historical database 119.

In the foregoing, configuration information management server apparatus 110 first searches, from among the records of configuration information history table 1500 shown in FIG. 15A, the record wherein “Router1” 1511 is associated as node identifier 1510, and identifies the concerned record. The element “2” 1521 is respectively stored as the most recent generation number 1520 in the record which is associated with node identifier “Router1” 1511, and as a pointer in generation information table 1530. Moreover, configuration information management server apparatus 110 follows the pointer to generation information table 1530 in the record and identifies generation information table 1530.

For example, in generation information table 1530, there are respectively stored the element “2” 1541 as generation number 1540, the element “2004/05/10 22:05” 1551 as generation registration date and time, and the element “router1_{—}20040510220500.conf” 1561 as configuration information file name 1560. Configuration information management server apparatus 110 associates configuration information file name “router1_{—}20040610223000.conf” 1562 with generation number “3” 1542 and generation registration date and time “2004/06/10 22:30” 1552, and generates a record in generation information table 1530, as shown in FIG. 15B. Also, configuration information management server apparatus 110 identifies most recent generation number 1520 in the concerned record of configuration information history table 1500, and updates datum 1521. Further, it is acceptable to provide a limit on the number of records stored in generation information table 1530.

In the following, the detailed process functioning of the configuration information collection and change detection in Sequence S350 in FIG. 3 will be explained with reference to the flow'shown in FIG. 4.
1. When the process of Sequence S350 is started, configuration information management server apparatus 110 first executes the configuration information collection process, by first establishing communication with the network device being the object of the configuration information collection process in accordance with the node information acquired from node information table 1100, shown in FIG. 11, of node information database 115, and then transmitting data needed for the collection of configuration information to the network device, in accordance with the contents of command file 151 acquired on the basis of command file name 1021 stored in a record of device type information table 1100 in device type information database 114, and receives configuration information from the network device (Step S400).

Further, in the embodiment of the present invention, the method is adopted wherein command information is described in the command file, but a method may also be adopted wherein a table is generated, the commands are stored in records, and there is sequential execution.
2. When configuration information management server apparatus 110 receives the configuration information from the network device, it determines whether it has been possible to collect the configuration information normally. In case it had not been possible to collect the configuration information normally (e.g. due to a password change or the like), it proceeds to the processes from Step 490, which will be described subsequently, and executes an error process (Step S405).
3. In case, in the judgment at Step S405, it was possible to normally collect the configuration information, a configuration information corrective process is executed by correcting the configuration information collected from the network device in accordance with the corrective pattern information of pattern file 152 stored in device type information database 114. The corrective pattern information used in this step is administered by a management process, to be subsequently described, for configuration information corrective pattern information, and is information utilized for correcting, into a uniform format configuration, information differing by device type in the description formats etc. collected from various different devices (Step S410). As a result of this, the corrected configuration information is information from which information unnecessary for the comparison has been removed, so making it information composed only of the minimum necessary information (i.e. only that part of the collected configuration information which is required for the comparison) for comparison with the information for validation use, leading to a projected increase in the efficiency of the comparison process.
4. Next, configuration information management server apparatus 110 saves the configuration information collected from the network device as temporary file 154 of configuration information, associates node identifier 1410, collection date and time 1420, and temporary file 1430 of configuration information to generate a record in table 1400 of temporarily archived configuration information, as shown in FIG. 14, and stores it in configuration information temporary archive database 118 (Step S420).
5. After termination of the process of storing the temporary file of configuration information at Step S420, configuration information management server apparatus 110 acquires file 153 of configuration information for validation use stored in database 117 for configuration information for validation use, and compares temporary file 154 of configuration information (i.e. the information in that part of the collected configuration information file that should be compared) and file 153 of configuration information for validation use (Step S430). Further, it is also acceptable for file 153 of configuration information for validation use to be corrected by using corrective pattern information and be composed only of the minimum necessary information for a comparison with the collected configuration information. In order to improve the efficiency of the comparing processing, the character string of the file 153 of the configuration information for validation is preferably same in the order as the character string of the temporary file 154.
6. In the comparison at Step S430, it is determined whether temporary file 154 of configuration information and file 153 of configuration information for validation use match, and in case temporary file 154 of configuration information and file 153 of configuration information for validation use [do] match, i.e. if the configuration information collected from the network device and the configuration information of the network device subject to a change performed from console apparatus 180 match, it is judged that the configuration information collection and change detection processes have come to a normal end, and a flag to that effect is raised and the process is ended. For example, the concerned record, in collection management information table 1300 shown in FIG. 13 and stored in collection management information database 116, is searched, and a label “Normal termination” 1361 is stored in an end state 1360 (Steps S435, S440).
7. On the other hand, in case, in the judgment at Step S435, temporary file 154 of configuration information and file 153 of configuration information for validation use do not match (i.e. in case the temporary file for configuration information is incorrect due to unauthorized alteration, entry mistake, or the like, or if the change is in progress or the process has not yet commenced), configuration information management server apparatus 110 determines whether or not the configuration information of the most recent generation (i.e. the most recent configuration information among the configuration information stored in the DB 116) is stored in configuration information file 155 of configuration information historical database 119 (Step S445).
8. In case, in the judgment at Step S445, the configuration information of the most recent generation is stored in configuration information historical database 119, configuration information management server apparatus 110 compares temporary file 154 of configuration information and configuration information file 155 of the most recent generation (Step S450).
9. As a result of the comparison at step S450, it is determined whether temporary file 154 of configuration information and configuration information file 155 of the most recent generation match. In case temporary file 154 of configuration information and configuration information file 155 of the most recent generation do not match, i.e. in case the configuration information collected from the network device differs both from the contents of the configuration information before changing the configuration information, and from the configuration information for validation use (i.e. in case the collected configuration information is incorrect due to unauthorized alteration or an entry mistake), a flag is raised to the effect that a change has been detected. Then, the concerned record in collection management information table 1300 stored in collection management information database 116 is searched, and after the label “Change detection” has been stored in end state 1360, the configuration information collection and change detection processes are ended (Steps S455, S480).
10. In case, in the judgment at Step S455, temporary file 154 of configuration information and configuration information file 155 of the most recent generation match, i.e. in case either the configuration information collected from the network device is not yet changed or the configuration information of the most recent generation, in the judgment at Step S445, is not stored in configuration information historical database 119, it is determined whether the change detection extension period has been ended or not. The change detection extension period is determined on the basis of collection start date and time “2004/06/10 21:00” 1331 and change detection extension period “60 min” 1351 in collection management information table 1360 (Step S456).
11. In case, in the judgment at Step S456, the change detection extension period has come to an end, a flag is raised to the effect that the change operations by the maintenance staff have not commenced, the concerned record in collection management information table 1300 stored in collection management information database 116 is searched, the label “change not yet commenced” is stored in end state 1360, and the configuration information collection and change detection processes are ended (Step S460).
12. In case, in the judgment at Step S456, the change detection extension period had not come to an end, the processes are continued by returning to the processes from Step S400. I.e., in case temporary file 154 of configuration information and file 153 of configuration information for validation use do not match, the configuration information collection process and change detection process are reiterated in this way.
13. In case, in the judgment of Step S405, it was not possible to normally collect the configuration information, a flag to the effect that the configuration information collection and change detection processes have ended abnormally is raised as an error process, the concerned record in collection management information table 1300 stored in collection management information database 116 is searched, and the label “abnormal end” is stored in end state 1360. Then, after this storage process, an error message is reported to client apparatus 160 according to a means set in advance, and the configuration information collection and change detection processes are ended (Steps S490, S357).

The embodiment of the present invention adopts a method, as the error process at Step S490, of reporting error messages by a means set in advance, to client apparatus 160, and as report contents, it is possible to adopt a method of reporting that it was not possible to collect the configuration information, or to report detailed contents, etc. Also, in the present invention, it is also possible to adopt the method of only storing data indicating the execution results of the configuration information change detection process in the collection management information table 1300 and not reporting error messages. On the other hand, in the embodiment of the present invention, there is adopted, in case a change in the configuration information has been detected, or in the case it has been detected that the change operations of the maintenance staff have not yet commenced, the method of searching the concerned record in collection management information table 1300 stored in collection management information database 116 and storing a label in response to the detected contents, but with the present invention, it is also possible to adopt the method of transmitting a report message to client apparatus 160 by a means set in advance.

As explained in the configuration information collection and change detection processes according to the aforementioned embodiment of the present invention, when, after executing the processes of Steps S445 to S455, the process of Step S456 is executed, it is possible, because a change in the configuration information is detected even within the change detection extension period, to attain higher security. On the other hand, if the maintenance staff executes the processes of Steps S445 to S455 during the change in configuration information, it ends up collecting configuration information while the change is in progress, i.e. configuration information different from both the configuration information for validation use and the configuration information of the most recent generation, so there is a possibility to determine that there is a configuration information change. In order to handle a case like this, it is also possible to adopt a method of executing Step S456 before executing Steps S445 to S455.

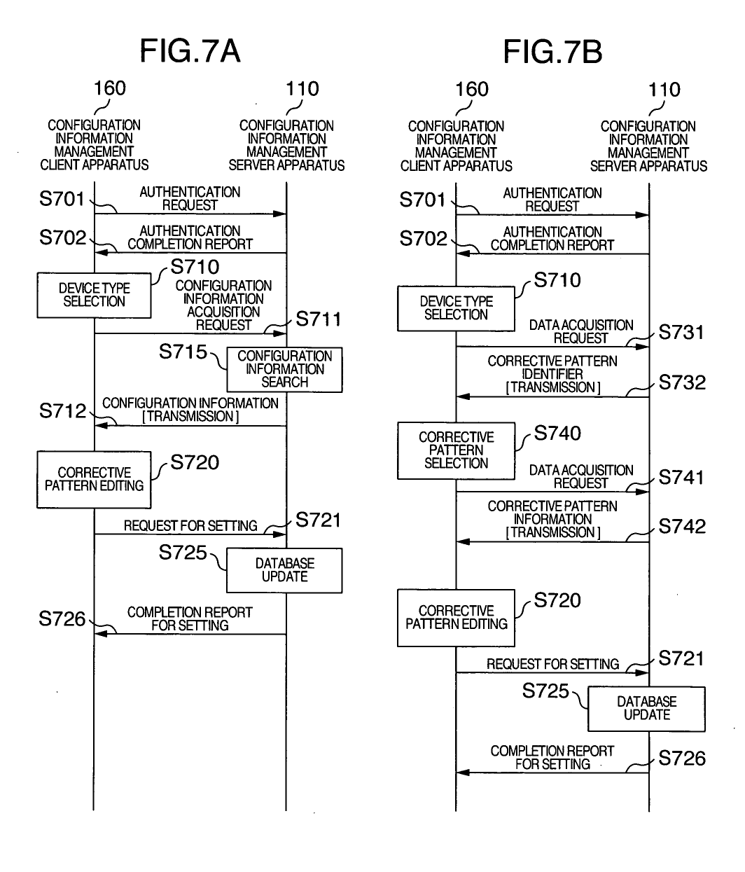

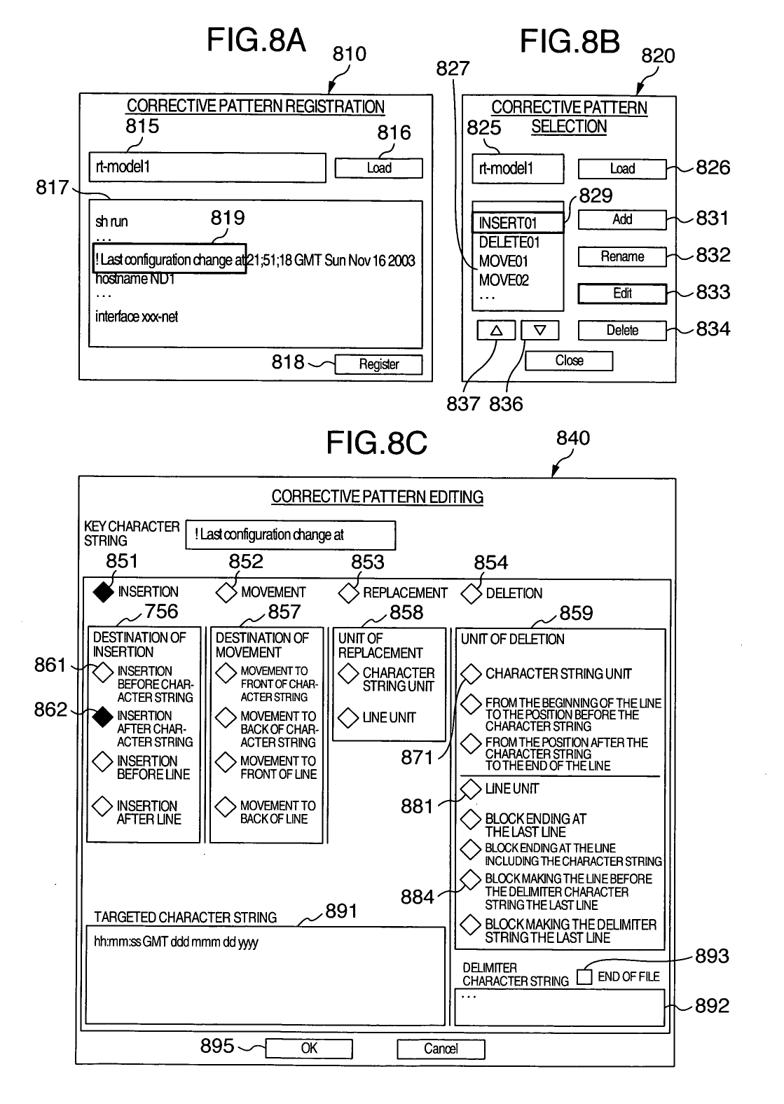

FIGS. 7A and 7B are sequence diagrams explaining the functioning of the processes whereby the configuration information management server apparatus 110 manages the corrective pattern information, FIGS. 8A, 8B, and 8C are diagrams showing windows displayed in the client apparatus in the configuration information corrective pattern process; in the following, the functioning of the processes managing the corrective pattern information will be explained with reference to FIGS. 7A and 7B and FIGS. 8A, 8B, and 8C. The processes managing the corrective pattern information include a registration process for configuration information corrective pattern information and an editing process for configuration information corrective pattern information, of which the operation of the registration process for configuration information corrective pattern information will be explained first, with reference to the sequences shown in FIG. 7A.
1. The user, together with instructions to perform the registration process for configuration information corrective pattern information, enters authentication information, including and composed of a user identifier and a password, from client apparatus 160. The client apparatus transmits the entered authentication information to configuration information management server apparatus 110 (Sequence S701).
2. Configuration information management server apparatus 110 transmits an authentication completion report to client apparatus 160. Due to the foregoing, the login of the user is completed, and a corrective pattern registration window 810 shown in FIG. 8A is displayed in client apparatus 160 (Sequence S702).
3. The user attempting to perform the registration of the configuration information corrective pattern information selects a device type entry field 815 from corrective pattern registration window 810 shown in FIG. 8A and displayed in client apparatus 160, and enters the character string of the device type identifier for the configuration information corrective pattern information that he wishes to register, here “rt-model1”. After that, when the user selects a “Load” button 816, client apparatus 160 transmits a configuration information acquisition request to configuration information management server apparatus 110 (Sequences S710, S711).
4. Configuration information management server apparatus 110, having received the configuration information acquisition request, searches the configuration information associated with the device type designated by the user (Sequence S715).

The specific process of Sequence S715 is a process wherein the record associated with the device type identifier “rt-model1” is searched from among the records in node information table 1100 shown in FIG. 11 and stored in node information database 115, and the node identifier group including node identifier “Router1” 1111 etc. is extracted. Also, it is a process wherein a record is searched, i.e. the record associated with the configuration information, in which pointers are stored to generation information table 1530, from among the records in configuration information history table 1500 shown in FIG. 15B and stored in configuration information historical database 119, and the node identifier group including node identifier “Router1” 1511 associated with the searched record, and the like, is extracted. Then, configuration information management server apparatus 110 takes the product of the plurality of node identifier groups associated with the device type identifier “rt-model1” and the node identifier group associated with the configuration information, selects a suitable node identifier from among the node identifier groups obtained as a result of taking the aggregate product, and acquires the configuration information associated with the node identifier.
5. When the aforementioned configuration information search process in the process of Sequence S715 comes to an end, configuration information management server apparatus 110 transmits the acquired configuration information to client apparatus 160. Client apparatus 160, having received this configuration information, displays the received configuration information in a corrective pattern character string selection field 817 of the displayed corrective pattern registration window 810 (Sequence S712).

Further, in case there are several concerned node identifiers stored in node information database 115, configuration information management server apparatus 110 synoptically displays the node identifiers of the search result to client apparatus 160 and makes a selection according to a method wherein the node name is selected by the user, a method wherein the node identifier appearing in the first position of the aggregate product is selected by the apparatus, a method wherein the node identifier for which the most recent generation number of the configuration information is the highest is selected by the apparatus, or the like, the method being settable in advance by the user.
6. When the user selects, as a key character string, a character string 819 of corrective pattern character string selection field 817 from corrective pattern registration window 810 of the client apparatus and selects a “Register” button 818, a corrective pattern edit window 840 shown in FIG. 8C is displayed in client apparatus 160, and the user performs a process of editing the corrective pattern using corrective pattern edit window 840 (Sequence S720). The key character string means a character string serving as a key for the correcting process, that is, a character string to be corrected, or a character string representing that a preceding or succeeding character string is subjected to the correcting process (e.g., insertion, deletion.)

In the process of editing the corrective pattern in Sequence S720, the user selects the item corresponding to the desired corrective mode, from among the correction mode items “Insertion” 851, “Movement” 852, “Replacement” 853, and “Deletion” 854, in corrective pattern edit window 840 displayed in client apparatus 160.

Next, the user selects the desired detailed setting item from among the detailed setting items associated with the selected corrective mode item. For example, in case the corrective mode item selected by the user is “Insertion” 851, the detailed setting items associated with the corrective mode item are items “Insertion before character string” 861, “Insertion after character string” 862, and so forth. After having selected the detailed setting item, the user enters the targeted character string in a targeted character string edit field 891. For example, in case the corrective mode item selected by the user is “Insertion” 851 and the detailed setting item is “Insertion after character string” 862, the character string entered in targeted character string edit field 891 is shown being inserted after the key character string. In case the representation format of the date and time character strings etc is defined, the user enters a character string serving as a suitable character string, such as “ddd mm dd yyyy”. Moreover, for example, in case the corrective mode item selected by the user is “Deletion” 854, the detailed setting item is “Character string unit” 871 etc., “Line unit” 881 etc., or “Block making the line before the delimiter character string the last line” 884 etc. After selecting the detailed setting item, the user enters the targeted character string in a delimiter character string edit window 892. If an item “end of file” 893 is made into the selected state, as the delimiter character string, it is assumed that the part of the file up to the last character is considered as the block.

Further, it is assumed that the character strings entered in targeted character string edit field 891 and delimiter character string edit field 892 may cover several lines.
7. If the user, after the end of the corrective pattern editing process in the process of Sequence S720 described above, selects an “OK” button 895 from corrective pattern edit window 840, client apparatus 160 transmits a request to set the configuration information corrective pattern information, to configuration information management server apparatus 110 (Sequence S721).
8. If configuration information management server apparatus 110 receives the request to set the configuration information corrective pattern information in Sequence S721 from client apparatus 160, it executes the process of setting the configuration information corrective pattern information, and stores the edited configuration information corrective pattern information in pattern file 152 of device type information database 114 to update the pattern file (Sequence S725).

In the process of setting the configuration information corrective pattern in Sequence S725, configuration information management server apparatus 110 extracts a pattern file label “model01.ptn” 1031 from corrective pattern information 1030 associated with the device type identifier “rt-model1” from among the records in device type information table 1000 shown in FIG. 10 and stored in device type information database 114, reads the concerned file into memory, and extracts the contents of the corrective pattern information stored in the file. Then, configuration information management server apparatus 110 generates corrective pattern information table 1600 in the memory and shown in FIG. 16, and stores the corrective pattern information extracted from the file in the record. The records of corrective pattern information table 1600 are records associating and storing pattern identifiers 1610, key character strings 1620, corrective modes 1630, detailed settings 1640, as well as targeted and/or delimiter character strings 1650.
9. After the end of the process of storing corrective pattern information in corrective pattern information table 1600, configuration information management server apparatus 110 stores each piece of corrective pattern information in corrective pattern information table 1600 of pattern file 152 in device type information database 114. After the end of the aforementioned process of setting the configuration information corrective pattern information, configuration information management server apparatus 110 transmits a setting completion report for the configuration information corrective patterns to the client apparatus (Sequence S726).

Further, in the aforementioned corrective pattern registration process in an embodiment of the present invention, a method of storing corrective pattern information in pattern file 152 and storing pattern file names in corrective patterns 1030 in the records of device type information table 1000 is adopted, but it is also possible, in the present invention, to adopt a method of storing corrective pattern information table 1600 in device type information database 114 and the like.

Next, the process of editing the configuration information corrective pattern information will be explained, with reference to the sequences shown in FIG. 7B.
1. The user, together with instructions to perform the registration process for configuration information corrective pattern information, enters authentication information, including and composed of a user identifier and a password, from client apparatus 160. The client apparatus transmits the entered authentication information to configuration information management server apparatus 110 (Sequence S701).
2. Configuration information management server apparatus 110 transmits an authentication completion report to client apparatus 160. Due to the foregoing, the login of the user is completed, and a corrective pattern selection window 820 shown in FIG. 8B is displayed in client apparatus 160 (Sequence S702).
3. The user attempting to perform a registration of the configuration information corrective pattern information selects a device type entry field 825 from corrective pattern selection window 820 shown in FIG. 8B and displayed in client apparatus 160, and enters the character string of the device type identifier for the configuration information corrective pattern that he wishes to edit, here “rt-model1”. After that, when the user selects a “Load” button 826, client apparatus 160 transmits a configuration information acquisition request to configuration information management server apparatus 110 (Sequences S710, S731).
4. Configuration information management server apparatus 110, having received the corrective pattern identifier acquisition request, reads into memory pattern file 152 of device type information database 114 associated with the device type designated by the user, extracts the corrective pattern identifier, and transmits the corrective pattern identifier to client apparatus 160. Client apparatus 160, having received the corrective pattern identifier, displays the corrective pattern identifier in a corrective pattern name display field 827 of the displayed corrective pattern selection window 820 (Sequence S732).
5. For example, if the user selects corrective pattern name “INSERT01” 829 in corrective pattern name display field 827 and the user selects an “Edit” button 833, client apparatus 160 transmits a request for acquisition of configuration information corrective pattern information to configuration information management server apparatus 110 (Sequences S740, S741).
6. Configuration information management server apparatus 110, having received the request for acquisition of configuration information corrective pattern information, with the same method as that for the process of registration of the configuration information corrective pattern information, generates corrective pattern information table 1600 in the memory and shown in FIG. 16, stores in the record the corrective pattern information extracted from pattern file 152, searches the record associated with a pattern identifier “INSERT01” 1611 from among the records in which corrective pattern information is stored, and transmits that pattern information to client apparatus 160 (Sequence S742).
7. Client apparatus 160, having received the corrective pattern information, displays corrective pattern edit window 840 shown in FIG. 8C. When the user, after having edited the corrective pattern information using corrective pattern edit window 840, selects “OK” button 895 from corrective pattern edit window 840, client apparatus 160 transmits a request for the setting of the configuration information corrective pattern information to configuration information management server apparatus 110 (Sequences S720, S721).
8. When configuration information management server apparatus 110 receives, in the process of Sequence S721, the request for the setting of the configuration information corrective pattern information from client apparatus 160, it executes the corrective pattern setting process. This process of setting the configuration information corrective pattern information is executed with the same method as that of the configuration information corrective pattern information registration process. After the end of the process of setting the configuration information corrective pattern information, configuration information management server apparatus 110 transmits a completion report for the setting of the configuration information corrective pattern information to the client apparatus (S725, S726).

In the processes of the sequences shown in FIG. 7B and explained in the foregoing, the explanation was given assuming that the user selected “Edit” button 833 from corrective pattern selection window 820 shown in FIG. 8B, but in the following an explanation will be given regarding the functioning of the processes for the case that the user selected another button.

In case the user, in the processes of the sequences shown in FIG. 7B and explained in the foregoing, selected an “Add” button 831 from corrective pattern selection window 820 shown in FIG. 8B, client apparatus 160 displays corrective pattern registration window 810, shown in FIG. 8A. Then, with the same method as in the process of registration of the configuration information corrective pattern information, it executes the process of editing the configuration information corrective pattern information. When configuration information management server apparatus 110 receives the request for setting of the configuration information corrective pattern information from the client apparatus (Sequence S721), it executes the process of setting the configuration information corrective pattern information and, after the end of the process of setting the configuration information corrective pattern information (Sequence S725), transmits a completion report for the setting of the configuration information corrective pattern information to the client apparatus (Sequence S726).

When client apparatus 160 receives the completion report for the setting of the configuration information corrective pattern information from configuration information management server apparatus 110 (Sequence S726), it adds the label of the registered corrective pattern information in corrective pattern display field 827 and displays it again.

Moreover, in the processes of the sequences shown in FIG. 7B and explained in the foregoing, in case the user selects a “Rename” button 832 from corrective pattern selection window 820 shown in FIG. 8B, client apparatus 160 displays a separate window including a name entry field. When the user enters the name and selects a button or the like designating a corrective pattern identifier change process, client apparatus 160 transmits a request for setting of the configuration information corrective pattern information (request for change of the corrective pattern identifier) to configuration information management server apparatus 110 (Sequence S721).

When configuration information management server apparatus 110 receives the request for setting of the configuration information corrective pattern information from the client apparatus in the process of Sequence S721, it executes the process of setting the configuration information corrective pattern information (Sequence S725) and, after the end of this process of setting the configuration information corrective pattern information, transmits a completion report for the setting of the configuration information corrective pattern information to client apparatus 160 (Sequence S726).

When client apparatus 160 receives the completion report for the setting of the configuration information corrective pattern information from configuration information management server apparatus 110 in the process of Sequence S726, it rewrites the label, of the corrective pattern information being the object of the name change process displayed in corrective pattern name display field 827, with the new name, and displays corrective pattern name display field 827 again.

Also, in the processes of the sequences shown in FIG. 7B and explained in the foregoing, in case the user selects a “Delete” button 834 from corrective pattern selection window 820 shown in FIG. 8B, client apparatus 160 transmits a request for the setting of the configuration information corrective pattern information (a corrective pattern information deletion request) to configuration information management server apparatus 110 (Sequence S721).

When configuration information management server apparatus 110 receives the request for the setting of the configuration information corrective pattern information from the client apparatus in the process of Sequence S721, it executes the process of setting the configuration information corrective pattern information (Sequence S725) and, after the end of this process of setting the configuration information corrective pattern information, it transmits a completion report for the setting of the configuration information corrective pattern information to client apparatus 160 (Sequence S726).

When client apparatus 160 receives the completion report for the setting of the configuration information corrective pattern information from configuration information management server apparatus 110 in the process of Sequence S726, it eliminates the label of the corrective pattern information being the object of the deletion process, displayed in corrective pattern name display field 827, and displays corrective pattern name display field 827 again.

Also, in the processes of the sequences shown in FIG. 7B and explained in the foregoing, when the user selects a “A” button 837 from corrective pattern selection window 820 shown in FIG. 8B, client apparatus 160 transmits a request for the setting of the configuration information corrective pattern information (a request for a change of the corrective pattern execution order) to configuration information management server apparatus 110 (Sequence S721).

When configuration information management server apparatus 110 receives the request for the setting of the configuration information corrective pattern information from client apparatus 160 in the process of Sequence S721, it executes the process of setting the configuration information corrective pattern information (Sequence S725). In case, in the process of Sequence S725, there is no other pattern name displayed above the corrective pattern name selected by the user, e.g. in case the user has selected the corrective pattern name “MOVE02”, the record associated with pattern identifier “MOVE02” and the record associated with pattern name “MOVE01” displayed above corrective pattern name “MOVE02” are respectively searched from among the records in corrective pattern information table 1600 shown in FIG. 16. The data stored in execution order 1660 in each respective record are replaced and stored.

After the end of the process of setting the configuration information corrective pattern information in the aforementioned process of Sequence S725, configuration information management server apparatus 110 transmits a completion report for the setting of the configuration information corrective pattern information to client apparatus 160 (Sequence S726).

When client apparatus 160 receives the completion report for the setting of the configuration information corrective pattern information from configuration information management server apparatus 110 in the process of sequence S726, the label of the corrective pattern information being the object of the execution order change process displayed in corrective pattern name display field 827 is moved to the top, and corrective pattern name display field 827 is displayed again.

In addition, in case the user, in the processes of the sequences shown in FIG. 7B and explained in the foregoing, selects a “∇” button 836 from corrective pattern selection window 820 shown in FIG. 8B and there is no other pattern name displayed below the corrective pattern name selected by the user, client apparatus 160 transmits a request for setting of the configuration information corrective pattern information (a request for a change of the corrective pattern execution order) to configuration information management server apparatus 110, in the same way as if “A” button 837 had been selected (Sequence S721).

When configuration information management server apparatus 110 receives the request for the setting of the configuration information corrective pattern information from the client apparatus, in the same way as if “Δ” button 837 had been selected in the process of Sequence S721, it executes the process of setting the configuration information corrective pattern information (Sequence S725).

After the end of the process of setting the configuration information corrective pattern information in the process of Sequence S725, configuration information management server apparatus 110 transmits a completion report for the setting of the configuration information corrective pattern information to client apparatus 160 (Sequence S726).

When client apparatus 160 receives the completion report for the setting of the configuration information corrective pattern information from configuration information management server apparatus 110 in the process of Sequence S726, it moves down the label, of the corrective pattern information being the object of the execution order change process, displayed in corrective pattern name display field 827 and displays corrective pattern name display field 827 again.

Each of the processes in the aforementioned embodiment of the present invention can be constituted as a process program, and it is possible to store and provide these process programs on a storage medium like HD (Hard Disk), DAT (Digital Audio Tape), FD (Floppy Disk), MO (Magneto-Optic Disk), DVD-ROM (Digital Versatile Disk—Read Only Memory), or CD-ROM (Compact Disk—Read Only Memory), etc.

According to the aforementioned embodiment of the present invention, in case a change in the configuration information is detected, since the file of configuration information for validation use has a file of configuration information for validation use corresponding to the change in network device configuration information to be performed from console apparatus 180, it is possible, by using this fact, to easily judge whether the detected change in configuration information is a regular change or whether it is an unauthorized alteration (an illicit change). Also, according to the embodiment of the present invention, since configuration information corrective pattern information is edited and registered, it is readily possible to exclude change portions which may be disregarded from the acquired configuration information, making it possible to reduce the man-hours required to compare configuration information to extract those parts which may be disregarded.

In the foregoing, an explanation was given of an embodiment of the present invention, but the explained embodiment is for the purpose of simplifying the comprehension of the present invention, and the present invention is not limited to the explained embodiment, it being possible to carry out changes and improvements without departing from its spirit.

It should be further understood by those skilled in the art that although the foregoing description has been made on embodiments of the invention, the invention is not limited thereto and various changes and modifications may be made without departing from the spirit of the invention and the scope of the appended claims.

1. A method, in a configuration information management apparatus communicatively connected to at least one network device and collecting and managing configuration information from the network device, for the management of configuration information of the network device, comprising the steps of:
in advance temporarily storing and saving configuration information for validation use, for configuring the network device, in the configuration information management apparatus;
comparing the configuration information collected from the network device with the saved configuration information for validation use; and
in case, as a result of the comparison, the information of that portion of the collected configuration information which should be compared matches the configuration information for validation use, storing the collected configuration information in a configuration information historical database.

2. A configuration information management method according to claim 1, wherein further, by the comparison, a judgment is performed on whether the configuring of the network device is normal or abnormal, wherein a fixed extension period is provided, from the start of collecting the configuration information until the point in time when the judgment is performed.

3. A configuration information management method according to claim 2, wherein further, after the fixed extension period, a judgment is made that the process of changing the configuration information has not yet commenced, in case the information of that portion of the collected configuration information which should be compared matches the configuration information for validation use.

4. A configuration information management method according to claim 1, wherein further,
that corrective pattern information is set for which a character string selected by the user is assumed to be the character string for the purpose of the configuration information correction process;
the collected configuration information is corrected using the corrective pattern information, wherein
the corrected collected configuration information is made the object of the comparison process.

5. A configuration information management apparatus, communicatively connected to at least one network device and collecting and managing the configuration information from the network device, the configuration information management apparatus comprising:
a storage unit for configuration information for validation use, for temporarily storing configuration information for validation use, for configuring the network device;
a comparator unit for configuration information, comparing the configuration information collected from the network device with the configuration information for validation use; and
a historical database for configuration information, storing the collected configuration information, in case the information of that portion of the collected configuration information which should be compared matches the configuration information for validation use.

6. A configuration information management apparatus according to claim 5 wherein a fixed extension period is provided, until the point in time that the configuration information comparator unit performs a judgment on whether the configuring of the network device is normal or abnormal by a comparison of the configuration information collected from the network device and the configuration information for validation use.

7. A configuration information management apparatus according to claim 6, wherein the configuration information comparator unit, after the fixed extension period, in case the information of that portion of the collected configuration information which should be compared matches the configuration information for validation use, makes a judgment that the process of changing the configuration information has not yet commenced.

8. A configuration information management apparatus according to claim 5, further provided with
a unit setting that corrective pattern information for which a character string selected by the user is assumed to be the character string for the purpose of the configuration information correction process; and
a unit correcting the collected configuration information in accordance with the corrective pattern information, wherein
the corrected collected configuration information is made the object of the comparison process.

9. A configuration information management apparatus, in a configuration information management system for network devices, the system being provided with the configuration information management apparatus communicatively connected to at least one network device and collecting and managing the configuration information from the network device and at least one configuration information management client apparatus communicatively connected to the configuration information management apparatus and wherein the configuration information management apparatus collects and manages the configuration information in accordance with the instructions from the configuration information management client apparatus, the configuration information management apparatus comprising:
a storage unit for configuration information for validation use, for temporarily storing configuration information for validation use for configuring the network device;
a comparator unit for configuration information, comparing the configuration information collected from the network devices with the configuration information for validation use; and
a historical database for configuration information, storing the collected configuration information,. in case the information of that portion of the collected configuration information which should be compared matches the configuration information for validation use.

10. A configuration information management system according to claim 9 wherein a fixed extension period is provided, until the point in time that the configuration information comparator unit performs a judgment on whether the configuration of the network device is normal or abnormal by a comparison of the configuration information collected from the network device and the configuration information for validation use.

11. A configuration information management system according to claim 10, wherein the configuration information comparator unit, after the fixed extension period, in case the information of that portion of the collected configuration information which should be compared matches the configuration information for validation use, makes a judgment that the process of changing the configuration information has not yet commenced.

12. A configuration information management system according to claim 9, further provided with
a unit setting that corrective pattern information for which a character string selected by the user is assumed to be the character string for the purpose of the configuration information correction process; and
a unit correcting the collected configuration information in accordance with the corrective pattern information, wherein
the corrected collected configuration information is made the object of the comparison process.
